(19) United States
(12) Patent Application Publication
(10) Pub. No.: US 2026/0017068 A1
(43) Pub. Date: Jan. 15, 2026

(54) METHOD AND DEVICE FOR AUTOMATICALLY GENERATING COMPUTER INSTRUCTIONS

(71) Applicant: UNIFIED SOFTWARE (YOO SOFT), Les Matelle (FR)

(72) Inventor: Eric QUIVY, Les Matelle (FR)

(21) Appl. No.: 18/993,595

(22) PCT Filed: Jul. 11, 2023
(86) PCT No.: PCT/EP2023/069241

§ 371 Date: Jan. 13, 2025

(30) Foreign Application Priority Data
Jul. 13, 2022 (FR) FR2207252
Mar. 17, 2023 (FR) FR2302498

(51) Int. Cl. G06F 9/445

(52) U.S. Cl. CPC G06F 9/44521; G06F 9/44536

(57) ABSTRACT

The invention relates to a computer-implemented method (300) for automatically generating instructions configured to be stored in a computer-readable storage medium and to be executed by at least one computer processor, which method comprises:
a step (105) of inputting, on a computer interface, at least:
a definition of a computer entity,
a structure of data associated with the computer entities, and
a software processing operation of at least one computer entity,
a step (110) of selecting, on a computer interface, an execution context for the instructions,
a step (115) of automatically generating, using a computing device, instructions depending on the result of the input step and the selected execution context and
a step (120) of storing, using a computing device, the instructions generated.

### TECHNICAL FIELD OF THE INVENTION

The present invention envisions a method for automatically generating computer instructions and a device for automatically generating computer instructions. It applies, in particular, to the field of automatically generating computer software systems.

### STATE OF THE ART

In the computer programming field, two types of software systems are known:
software systems referred to as “specific”, i.e. designed to be deployed for a specific purpose; and
software systems referred to as “standardised”, i.e. designed to be deployed in a repeated way, and can comprise customised elements.

Today, computer programming requires specialised skills, restricting the ability of individuals to create software for their needs.

Approaches known as “no code” are known, i.e. approaches which require no programming skills and which allow specific software systems to be produced. In these approaches, a user defines objects and interactions between these objects by means of a graphic interface allowing these defined interactions to be converted into computer instructions by means of a converter.

Beyond the generation of such software systems, the optimised deployment and operation of such software systems is outside the scope of operators who do not have suitable technical skills. Yet an unsuitable deployment can result in technical malfunctions of the software, or even its shutdown.

However, these approaches have several significant technical drawbacks:
their execution may be unsuitable for their hardware deployment and execution environment, leading to malfunctions of this hardware;
their consumption of software resources (memory) for deployment and execution can be high because of this unsuitability;
their consumption of physical resources (electricity) for deployment and execution can be high because of this unsuitability; and
their lack of modularity does not allow standardised software to be generated.

In particular, systems are known such as those described in document US 2021/149648. Such a system prompts a user to selects a programming language and a use for a software system. This choice leads to the selection of a predefined template and the generation of the corresponding code. The user then inputs the computer code to be injected, corresponding to a desired business logic, this computer code being inserted directly into the generated template. Such a system is known as “low-code”, i.e. a software system in which the main structure of the code is pre-generated and with which a user has only a marginal interaction by adapting the structure to a use (corresponding to a business logic).

Such systems make it possible to generate standardised software systems from choices initially made by a user.

### Subject of the Invention

The present invention aims to remedy all or part of these drawbacks.

To this end, according to a first aspect, the present invention envisages a computer-implemented method for automatically generating instructions configured to be stored in a computer-readable storage medium and to be executed by at least one computer processor, which method comprises:
a step of inputting, on a computer interface, at least:
a definition of a computer entity,
a structure of data associated with the computer entities, and
a software processing operation of at least one computer entity;
a step of selecting, on a computer interface, an execution context for the instructions;
a step of automatically generating, using a computing device, instructions depending on the result of the input step and the selected execution context; and
a step of storing, using a computing device, the instructions generated.

Thanks to these provisions, the instructions generated, forming a standardised or specific software system, are technically optimised for their execution context. This advantage allows the software to be adapted technically, and a single input can therefore result in several different sets of instructions, each corresponding to an execution context of these instructions. This substantially changes the operation of the ordinary development-deployment-execution system, in which the instructions to be executed are developed directly and are either not optimised or are input manually.

The utilisation of the method that is the subject of the present invention makes it possible to define, generate, deploy and operate one or more software systems.

In some optional embodiments, the method that is the subject of the present invention comprises:
a step of inputting, on a computer interface, a value representative of a deployment environment of the instructions generated; and
a step of automatically providing, using a computing device, deployment instructions for the instructions generated according to the value representative of a deployment environment input.

These embodiments make it possible to optimise the instructions generated automatically for the execution context and for the computer runtime environment.

In some optional embodiments, the method that is the subject of the present invention comprises a step of automatically deploying, using a computing device, instructions generated according to the deployment instructions supplied.

These embodiments make it possible to optimise the instructions generated automatically for the execution context and for the computer runtime environment.

In some optional embodiments, the generation step comprises a step of template enrichment, using a computing device, performed depending on the result of the input step.

Such an enrichment step allows the generation of instructions to be made easier by automatically establishing variable names or tables, for example.

In some optional embodiments, the generation step comprises:
a first step of generating, using a computing device, computer execution instructions depending on the result of the input step and the selected execution context; and
a second step of generating, using a computing device, mobile device execution instructions depending on the result of the input step and the selected execution context.

These embodiments make it possible to optimise the execution of the computer program generated for desktop or laptop computers, and for mobile devices such as a smartphone or tablet for example.

In some optional embodiments, the method that is the subject of the present invention comprises:
a step of modifying, on a computer interface, at least:
a definition of a computer entity,
a structure of data associated with the computer entities, and/or
a software processing operation of at least one computer entity; and
a step of automatically generating, using a computing device, instructions modified depending on the result of the modification step and the selected execution context; and
a step of storing, using a computing device, the instructions modified.

These embodiments make it possible to optimise the instructions generated during an update of these instructions by a user.

In some optional embodiments, the method that is the subject of the present invention comprises a step of automatically establishing, using a computing device, upgrade instructions according to the modified instructions generated.

These embodiments make it possible to automate the upgrading of software already deployed in execution environments.

In some optional embodiments, the method that is the subject of the present invention comprises a step of upgrading, using a computing device, instructions deployed in a selected execution environment, according to the upgrade instructions established.

These embodiments make it possible to automate the upgrading of software already deployed in execution environments.

In some optional embodiments, the method that is the subject of the present invention comprises a step of automatically detecting a version change for a library of functions utilised during a step of generating instructions, the automatic generation step being performed based on the change detected.

These embodiments make it possible to automatically update all the software generated without requiring action by an operator.

According to a second aspect, the present invention envisions a computer-implemented method for automatically generating an application environment comprising at least two software systems, each software system being formed of instructions configured to be stored in a computer-readable storage medium and to be executed by at least one computer processor, which method comprises:
a step of inputting, on a computer interface, at least:
a common definition of a computer entity,
a common structure of data associated with the computer entities, and
a common software processing operation of at least one computer entity;
a step of selecting, on a computer interface, at least two different execution contexts for the instructions;
a step of automatically generating, using a computing device, for at least two said software systems, instructions depending on the result of the input step and at least two selected execution contexts; and
a step of storing, using a computing device, for each software system, the instructions generated.

Thanks to these provisions, an application ecosystem can be generated automatically. This ecosystem can therefore utilise common entities, common data structures and adapted software processing operations in different application contexts. As a result of these provisions, the software systems thus generated utilise a single data definition.

In addition, thanks to these provisions, the present invention makes it possible to obtain isolation between the functional part of the software definition and the technological implementation of the generation of instructions. It is therefore possible to change the technology generating instructions, or even the language or library of functions, hereinafter called “framework”, without compromising the operation of the software generated or the means performing the input step.

In some optional embodiments, the method that is the subject of the present invention comprises:
a step of modifying, on a computer interface, at least:
a common definition of a computer entity,
a common structure of data associated with the computer entities, and
a software processing operation of at least one computer entity; and
a step of automatically generating, using a computing device, for at least two said software systems, instructions modified depending on the result of the modification step and the selected execution context; and
a step of storing, using a computing device, for each software system, the instructions generated.

According to a third aspect, the present invention envisions a device for automatically generating instructions configured to be stored in a computer-readable storage medium and to be executed by at least one computer processor, which device comprises:
a means for inputting, on a computer interface, at least:
a definition of a computer entity,
a structure of data associated with the computer entities, and
a software processing operation of at least one computer entity;
a means for selecting, on a computer interface, an execution context for the instructions;
a means for automatically generating, using a computing device, instructions depending on an item of information input by the input means and the selected execution context, which comprises, for each said software system, a step of filtering the entities input depending on the selected execution context associated with the software; and
a means for storing, using a computing device, the instructions generated.

This second aspect has the same advantages as the method that is the subject of the first aspect of the present invention.

### BRIEF DESCRIPTION OF THE FIGURES

Other advantages, aims and particular features of the invention will become apparent from the non-limiting description that follows of at least one particular embodiment of the method and device that are the subjects of the present invention, with reference to drawings included in an appendix, wherein:

FIG. 1 represents, schematically and in the form of a logical diagram, a first particular series of steps of the method that is the subject of the present invention;

FIG. 2 represents, schematically, a particular embodiment of the device that is the subject of the present invention.

FIG. 3 represents, schematically and in the form of a logical diagram, a second particular series of steps of the method that is the subject of the present invention;

FIG. 4 represents, schematically, an example of computer architecture making it possible to implement the method that is the subject of the present invention;

FIG. 5 represents, schematically, an example of software architecture making it possible to implement the method that is the subject of the present invention; and

FIG. 6 represents, schematically and in the form of a logical diagram, a third particular series of steps of the method that is the subject of the present invention.

### DESCRIPTION OF THE EMBODIMENTS

The present description is given in a non-limiting way, in which each characteristic of an embodiment can be combined with any other characteristic of any other embodiment in an advantageous way.

As can be seen from reading the present description, different inventive concepts can be implemented by one or more methods or devices described below, several examples of which are given here. The actions or steps performed in the framework of realising the method or device can be ordered in any appropriate way. As a consequence, it is possible to construct embodiments in which the actions or steps are performed in a different order from the one shown, which can include executing some acts simultaneously, even if they are presented as sequential acts in the embodiments shown.

The indefinite articles “one” or “a”, as used in the description and in the claims, must be understood as meaning “at least one”, except when the contrary is clearly indicated.

The expression “and/or”, as it is used in the present document and in the claims, must be understood as meaning “one or other, or both” of the elements thus connected, i.e. elements that are present conjunctively in some cases and disjunctively in other cases. The multiple elements listed with “and/or” must be interpreted in the same way, i.e. “one or more” of the elements thus connected. Other elements can possibly be present, other than the elements specifically identified by the clause “and/or”, whether or not they are linked to these specifically identified elements. Therefore, as a non-limiting example, a reference to “A and/or B”, when it is used in conjunction with open-ended language such as “comprising”, can refer, in one embodiment, to A only (possibly including elements other than B); in another embodiment, to B only (possibly including elements other than A); in yet another embodiment, to A and B (possibly including other elements); etc.

As used here in the description and in the claims, “or” must be understood as having the same meaning as “and/or” as defined above. For example, when separating elements in a list, “or” or “and/or” must be interpreted as being inclusive, i.e. the inclusion of at least one, but also of more than one, of a number or a list of elements, and, optionally, of additional elements not listed. Only the terms clearly indicating the contrary, such as “only one of” or “exactly one of”, or, when they are used in the claims, “consisting of”, refer to the inclusion of a single element of a number or a list of elements. In general, the term “or” as it is used here must only be interpreted as indicating exclusive alternatives (i.e. “one or the other, but not both”) when it is preceded by exclusivity terms, such as “either”, “one of”, “only one of”, or “exactly one of”.

As used here in the present description and in the claims, the expression “at least one”, in reference to a list of one or more elements, must be understood as meaning at least one element chosen from among one or more elements in the list of elements, but not necessarily including at least one of each element specifically listed in the list of elements and not excluding any combination of elements in the list of elements. This definition also allows the optional presence of elements other than the elements specifically identified in the list of elements to which the expression “at least one” refers, whether or not they are linked to these specifically identified elements. Therefore, as a non-limiting example, “at least one of A and B” (or, equivalently, “at least one of A or B” or, equivalently, “at least one of A and/or B”), can refer, in one embodiment, to at least one, possibly including more than one, A, with no B present (and possibly including elements other than B); in another embodiment, to at least one, possibly including more than one, B, with no A present (and possibly including elements other than A); in yet another embodiment, to at least one, possibly including more than one, A and at least one, possibly including more than one, B (and possibly including other elements); etc.

In the claims, and also in the description below, all the transitive expressions such as “comprising”, “including”, “bearing”, “having”, “containing”, “involving”, “made of”, “formed of” and others, must be understood as being open, i.e. meaning including, but not limited to. Only the transitive expressions “consisting of” and “consisting essentially of” must be understood as closed or semi-closed expressions, respectively.

In the present description, the terms “input means”, “means for inputting” and “computer interface” refer to any device making it possible to transmit information to a computer system. Such an input means is, for example, a keyboard, a mouse and/or a touch screen suitable for interacting with a computer system so as to collect an input from the user. In some variants, the input means is a software type, such as a network port of a computer system configured to receive an input command transmitted electronically. Such an input means can be associated to a Graphic User Interface (GUI) presented to a user, or to an Application Programming Interface (API). In other variants, the input means can be a sensor configured to measure a specified physical parameter pertinent to the intended use case.

The term “computing device” refers to any electronic computing device, single or distributed, able to receive digital inputs via and supply digital outputs to any type of digital interface. Typically, a computing device refers to either a computer executing software having access to a data storage, or a client-server architecture in which the data and/or at least a part of the calculations performed are on the server side while the client side serves as an interface.

The terms “digital identifier” refers to any item of information unequivocally representative of a physical or logical object. Such a digital identifier is, for example, an identifier in a database.

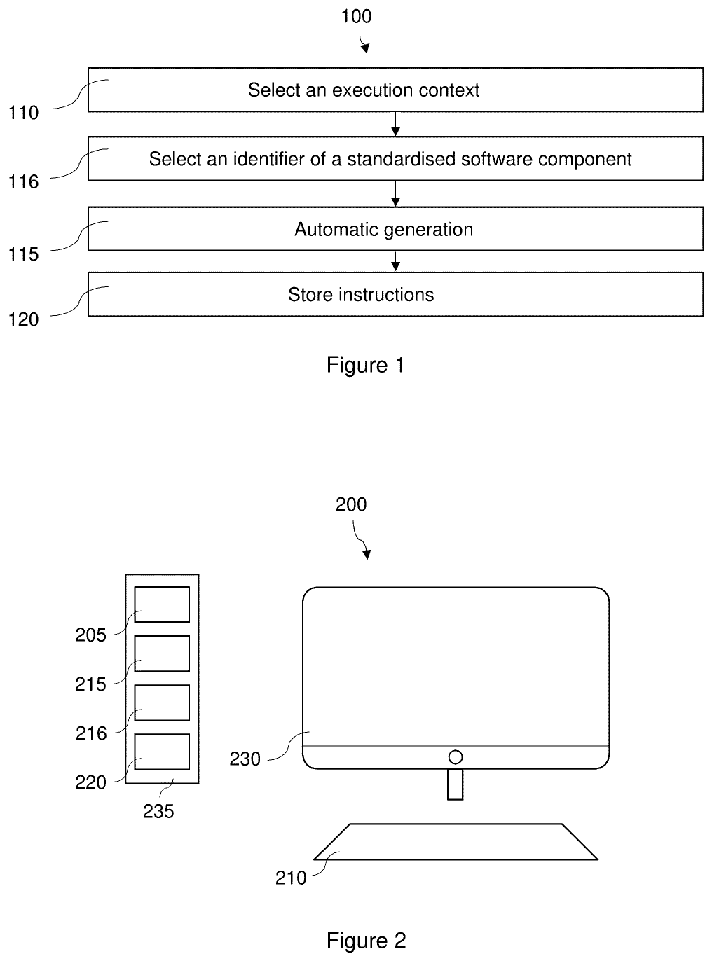

FIG. 1 shows a first particular series of implementation steps of the method 100 that is the subject of the present invention. This computer-implemented method 100 for automatically generating instructions configured to be stored in a computer-readable storage medium and to be executed by at least one computer processor, which method comprises:
a step 105 of inputting, on a computer interface, at least:
a definition of a computer entity,
a structure of data associated with the computer entities, and
a software processing operation of at least one computer entity;
a step 110 of selecting, on a computer interface, an execution context for the instructions;
a step 115 of automatically generating, using a computing device, instructions depending on the result of the input step and the selected execution context; and
a step 120 of storing, using a computing device, the instructions generated.

The input step 105 is performed, for example, by utilising computer software executed by a computing device. This computer software presents, for example, a graphic interface enabling a user to define:
a definition of a computer entity,
a structure of data associated with the computer entities, and
a software processing operation of at least one computer entity.

A computer entity, or “business entity” is associated to a name, or digital identifier, and has a master fieldset. This master fieldset has from 0 to N child fieldsets. Each of the child fieldsets can itself have from 0 to N child fieldsets. And so on, recursively and with no limit. The only constraint is that the structure is therefore hierarchical. Each table can only have a maximum of one child fieldset. If this is not the case then, to cover the need, this means that the entity must be split into two separate business entities.

As an illustration, a software system created in this way by a user can comprise:
an entity called “customer”, which comprises a single fieldset containing a field “last name” and a field “first name”;
an entity called “product”, which comprises a single fieldset containing a field “reference”; and
an entity called “order”, which comprises three fieldsets:
a first fieldset, called “header”, containing a field “order number”;
a second fieldset, called “lines”, containing a field “line number”, a field “unit price”, a field “quantity”, and a field “line amount”; and
a third fieldset, called “payment”, containing a field “payment number” and a field “amount paid”.

A software processing operation can be defined by a user, on the graphic interface of the creation software, by defining, for example, the behaviour of a button of an interface of the software being created. Such behaviour can correspond, for example, to performing a computation according to a value input in an input field by a user of the software.

A software processing operation can consist, for example, of counting the number of lines in a data table, or of performing a mathematical operation between two numeric values. Such an example of a software processing operation is, for example, the definition of a cut-off date for sending a package, by adding a given number of days to an order receipt data. These two values can be associated with different entities. In another example, a value corresponding to an order amount, excluding taxes, is calculated based on the values of individual amounts, excluding taxes, of products associated with a user's order.

The selection step 110 is performed, for example, by utilising computer software executed by a computing device. This computer software presents, for example, a graphic interface enabling a user to choose, from a list of use contexts for instructions, at least one such context. A use context can be, for instance, as a non-limiting example:
online sales (“e-commerce”) software;
enterprise resource planning (or ERP) software;
warehouse management system (or WMS) software;
business intelligence (or BI) software;
software for a mobile device; and/or
software for a store.

The generation step 115 is performed, for example, by utilising computer software executed by a computing device. During this generation step 115, at least one computer technology, like a computer language or a computer architecture, suitable for the execution context selected during the selection step 110, is chosen. Preferably, a plurality of technologies is selected to correspond to a set of basic software bricks such as, for instance, as a non-limiting example:
a backend architecture;
a backend language;
a frontend technology; and
a persistence layer technology.

As an illustration, the following table 1 presents six examples of such selections according to a possible execution context.

TABLE 1

| Type of | Backend | Backend | Frontend | |
|---|---|---|---|---|
| software | architecture | language | technology | Persistence layer |
| e-commerce | Micro-services | Java/.Net | Flutter - Web | SGBDr |
| | | | | (PostgreSQL) |
| ERP | Micro-services | Java/.Net | Flutter - Web | SGBDr(PostgreSQL) |
| WMS | Micro-services | Java/.Net | Flutter - Web | SGBDr(PostgreSQL) |
| Business | N/A | N/A | Power BI | BdD Snowflake |
| Intelligence | | | | |
| (BI) | | | | |
| Mobile | N/A | N/A | Flutter - | SCBDr Embedded |
| | | | Mobile | SQLite |
| Store | N/A | N/A | Flutter - | SCBDr Embedded |
| | | | Mobile | SQLite |

During this generation step 115, based on a programming language or a framework utilised, the instructions are generated. This generation step 115 is performed by a converter, configured to convert the input entities, data structures and software processing operations into instructions in a given language or framework.

During this generation step 115, for example, according to the execution context selected, the values input during the input step 105 are associated to templates to produce instructions. The number and type of these templates depend, for example, on the execution context selected.

For example, in the case of a mobile device execution context:
all or part of the values input are associated to a screen section management template to produce one class per screen section, thereby constituting a user interface layer;
all or part of the values input are associated to a user interface controller (or UI Controller) management template to produce one class per screen, thereby constituting a user interface controller;
all or part of the values input are associated to an entity service template to produce one class per entity;
all or part of the values input are associated to a rules service template to produce one class per rule;
all or part of the values input are associated to a process service template to produce one class per process, the entity, rule and process classes thereby constituting a service layer; and
all or part of the values input are associated to a fieldset repository template to produce one class per fieldset, thereby constituting a repository layer.

For example, in the case of a web software context:
all or part of the values input are associated to a screen section management template to produce one class per screen section, thereby constituting a user interface layer;
all or part of the values input are associated to a user interface controller (or UI Controller) management template to produce one class per screen, thereby constituting a user interface controller;
all or part of the values input are associated to an entity service template to produce one class per entity;
all or part of the values input are associated to a data interface controller template to produce one class per data interface;
all or part of the values input are associated to a rules service template to produce one class per rule;
all or part of the values input are associated to a process service template to produce one class per process, the entity, data interface and process classes thereby constituting a service layer; and
all or part of the values input are associated to a fieldset repository template to produce one class per fieldset, thereby constituting a repository layer.

The step 120 of storing instructions performed, for example, by utilising a local or remote computer memory, i.e. associated directly to the terminal performing the input step 105 or associated with this terminal via a data network, such as the internet for example.

This storage step 120 utilises, for example, a hard disk, a solid-state drive (or SSD), or a computer server.

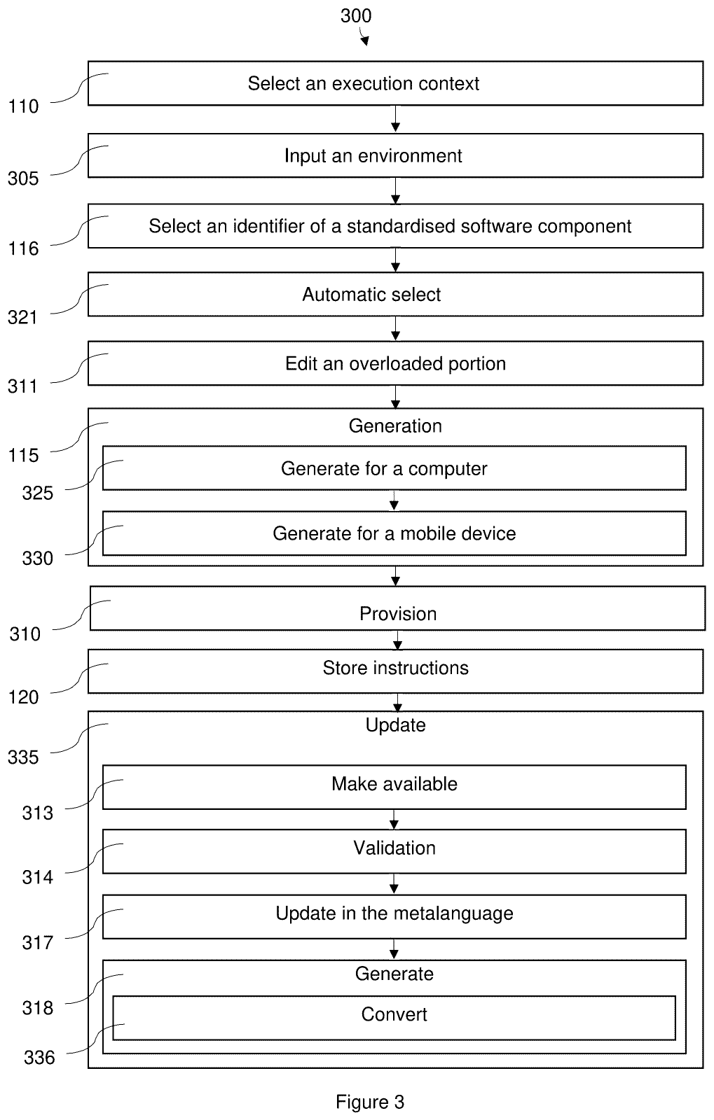

FIG. 2 shows, schematically, an embodiment of the device 200 that is the subject of the present invention. This device 200 for automatically generating instructions configured to be stored in a computer-readable storage medium and to be executed by at least one computer processor, which device comprises:
a means 205 for inputting, on a computer interface 210, at least:
a definition of a computer entity,
a structure of data associated with the computer entities, and
a software processing operation of at least one computer entity;
a means 215 for selecting, on a computer interface, an execution context for the instructions;
a means 220 for automatically generating, using a computing device 230, instructions depending on an item of information input by the input means and the selected execution context; and
a means 225 for storing, using a computing device, the instructions generated.

The input means 205 is, for example, a computer peripheral enabling a user to interact with a graphic interface making it possible to define entities, data structures and software processing operations.

The input means 215 is, for example, a computer peripheral enabling a user to interact with a graphic interface making it possible to select an execution context.

The automatic generation means 220 is, for example, a software system utilised by a computing device configured to translate the input made by the user into technological choices corresponding to the selected execution context and into the generation of instructions corresponding to these technological choices.

The storage means 225 is, for example, a local or remote computer memory.

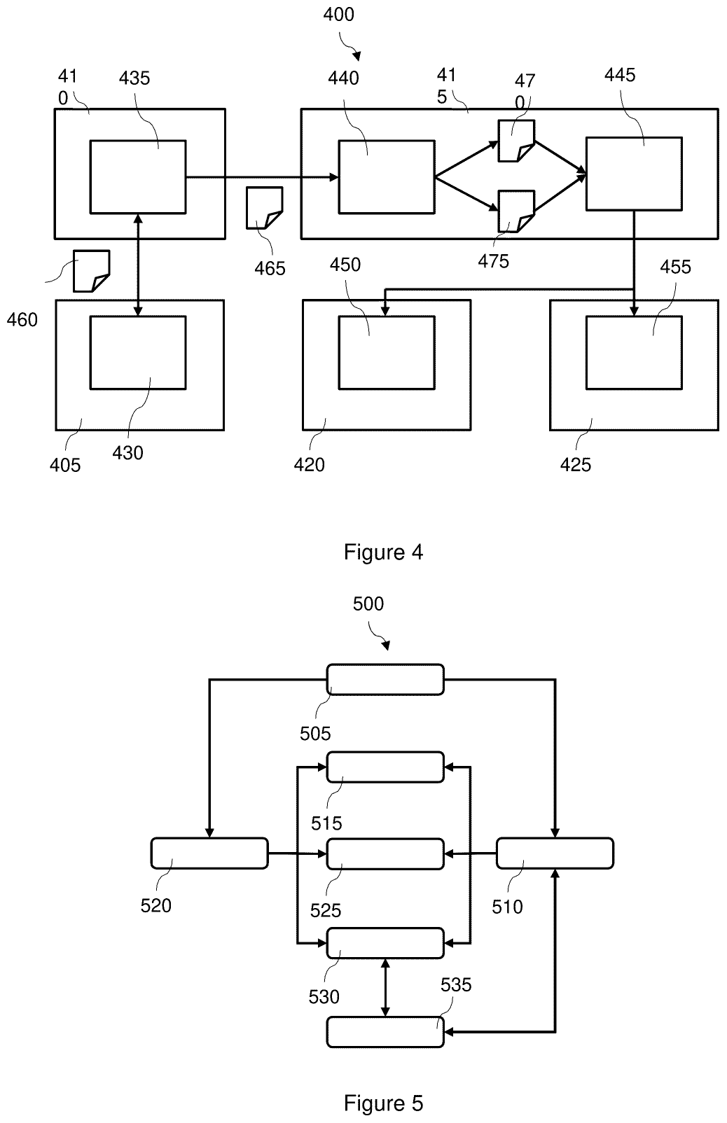

FIG. 3 shows a second particular series of implementation steps of the method 300 that is the subject of the present invention. This computer-implemented method 300 for automatically generating instructions configured to be stored in a computer-readable storage medium and to be executed by at least one computer processor, which method comprises:
a step 105 of inputting, on a computer interface, at least:
a definition of a computer entity,
a structure of data associated with the computer entities, and
a software processing operation of at least one computer entity;
a step 110 of selecting, on a computer interface, an execution context for the instructions;
a step 115 of automatically generating, using a computing device, instructions depending on the result of the input step and the selected execution context; and
a step 120 of storing, using a computing device, the instructions generated.

This method 300 has a plurality of embodiments and variants of the method 100 as described with regard to FIG. 1.

In some particular embodiments of the method 300 that is the subject of the present invention, the method 300 comprises:
a step 305 of inputting, on a computer interface, a value representative of a deployment environment of the instructions generated; and
a step 310 of automatically providing, using a computing device, deployment instructions for the instructions generated according to the value representative of a deployment environment input.

The input step 305 is performed, for example, by utilising computer software executed by a computing device. Such a software system has, for example, a graphic interface enabling a user to input, from a list of predefined deployment environments, at least one deployment environment for the software generated.

Such an example of a deployment environment can be, for example, a virtual machine or a dedicated server. Each deployment environment is associated to technical characteristics, such as an operating system for example, currently requiring an adapted deployment.

The provision step 310 is performed, for example, by utilising computer software executed by a computing device. During this provision step 310, instructions specific to a deployment environment are generated. These instructions comprise, for example, the transfer of the software generated to a hosting resource, and then the deployment of this software on a computing resource for example.

In some particular embodiments of the method 300 that is the subject of the present invention, the method 300 comprises a step 315 of automatically deploying, using a computing device, instructions generated according to the deployment instructions supplied.

The deployment step 315 is performed, for example, by utilising computer software for deployment executed by a computing device. During the deployment step 315, the deployment instructions (or deployment “script”) are executed and make it possible, for example, to initialise a deployment environment, create a database in this environment and deploy the software generated.

In some particular embodiments of the method 300 that is the subject of the present invention, the generation step 115 comprises a step 320 of template enrichment, using a computing device, performed depending on the result of the input step 105.

During this enrichment step 320, for example, variable names are initialised to facilitate the generation of instructions in a given framework. This enrichment step 320 is performed according to the operational needs of the instruction generation framework chosen for the software.

During this enrichment step 320, for example, an object template corresponding to the input made by the user is produced and links are established between instances of classes in accordance with the links described in the template.

An additional template is then preferably generated per target language, such an additional template comprising, for example, a handler, possibly linked, for each constituent of the template (e.g. entity, data field, field, software) and information (e.g. class, field, table names) defining how the instructions must be generated.

In some particular embodiments of the method 300 that is the subject of the present invention, the generation step 115 comprises:
a first step 325 of generating, using a computing device, computer execution instructions depending on the result of the input step 105 and the selected execution context; and
a second step 330 of generating, using a computing device, mobile device execution instructions depending on the result of the input step 105 and the selected execution context.

Structurally, the first and second generation steps, 325 and 330, are performed in a similar way to the generation step 115. The instructions generated in this way are adapted to their environment of utilisation by the users.

In some particular embodiments of the method 300 that is the subject of the present invention, the method 300 comprises:
a step 335 of modifying, on a computer interface, at least:
a definition of a computer entity,
a structure of data associated with the computer entities, and/or
a software processing operation of at least one computer entity; and
a step 340 of automatically generating, using a computing device, instructions modified depending on the result of the modification step and the selected execution context; and
a step 345 of storing, using a computing device, the instructions modified.

The modification step 335 is performed in a similar way to the input step 105. For example, during this modification step 335, a user modifies an entity to add a field representing an amount including taxes of an order, and modifies a software processing operation to add the calculation of an amount including taxes, utilising a field already existing in a previous version of the software representative of the amount excluding taxes of the order, and applying a given multiplication factor, corresponding to the taxes on this order, to it. All of this can be performed in a graphic interface, by a user, by modifying an entity already created and adding a software processing operation making it possible to calculate the new value of this entity.

The automatic generation step 340 is performed in a similar way to the generation step 115. For example, during this generation step 340, a field corresponding to an order value including taxes is added to an entity representative of the order. Next, two functions, get or set, are automatically generated for this field. Next, a class is generated making it possible to implement the process calculating the field.

The storage step 345 is performed in a similar way to the storage step 120.

A modification is here understood as an update to the generated instructions, by adding, modifying or deleting instructions. This update can be performed by a user by means of a graphic interface. Such an update can consist of the modification, addition or deletion of an entity or a software processing operation applied to an entity, for example.

In some particular embodiments of the method 300 that is the subject of the present invention, the method 300 comprises a step 350 of automatically establishing, using a computing device, upgrade instructions according to the modified instructions generated.

The upgrade instructions make it possible in particular to define how to migrate a software system's data from one version to another.

For example if a field is added in a table that already exists in a previous version of the software, the value of this field in the already existing records must be initialised. Such an initialisation can be defined by a calculation rule.

In some optional embodiments of the method 300 that is the subject of the present invention, the method 300 comprises a step 355 of upgrading, using a computing device, instructions deployed in a selected execution environment, according to the upgrade instructions established.

The upgrade step 355 is performed, for example, by utilising upgrade computer software executed by a computing device. During the upgrade step 355, the upgrade instructions (or upgrade “script”) are executed and make it possible, for example, to update a deployment environment, modify a database in this environment and deploy a new version of a software system already deployed in this environment.

In some optional embodiments of the method 300 that is the subject of the present invention, the method 300 comprises a step 360 of automatically detecting a version change for a library of functions utilised during a step 115 of generating instructions, the automatic generation step 340 being performed based on the change detected.

The automatic detection step 360 is performed, for example, by utilising software executed by a computing device. During this detection step 360, for example, an identifier of a framework or framework version is associated with a set of instructions generated during a generation step 115 or establishment step 350. When a reference framework or framework version identifier—either defined manually by an administrator of the system making it possible to input entities, data structures and software processing operations, or defined automatically—differs from the framework or framework version identifier associated to a set of instructions, the automatic generation step 340 is utilised. During the generation step 340, a set of instructions updated according to the reference framework or framework version identifier is generated.

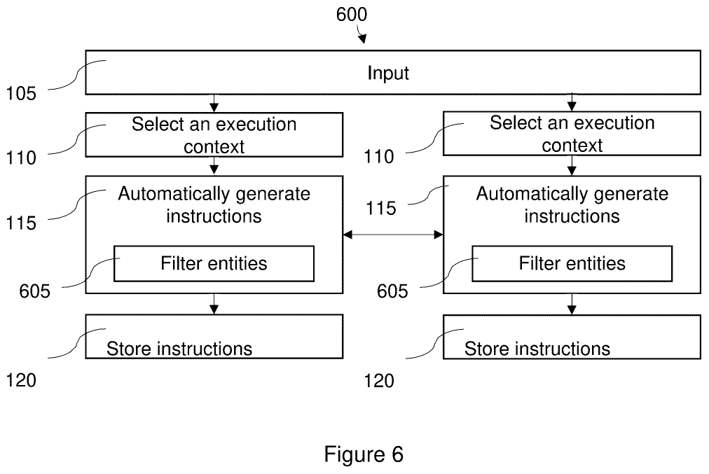

FIG. 4 shows schematically an architecture 400 utilising the method 200 that is the subject of the present invention. This architecture 400 comprises:
a computer 405 configured to display a user interface 430 making it possible for a user to input entities, data structures and software processing operations to be carried out, this input can be facilitated by utilising templates 460 corresponding to typical software cases;
a computer server 410 for executing the input software 435 associated to the user interface 430;
a computer server 415 for converting the input into instructions and for deploying the instructions generated in this way, configured to execute:
a software system 440 for generating instructions, from predefined templates 465, to generate standard software systems, 470 and 475; and
a deployment engine 445 for deploying software systems, 470 and 475, generated in this way.

This architecture 400 therefore makes it possible to automatically generate and deploy, on several computers, 420 and 425, several software systems, 450 and 455, which can be identical or different.

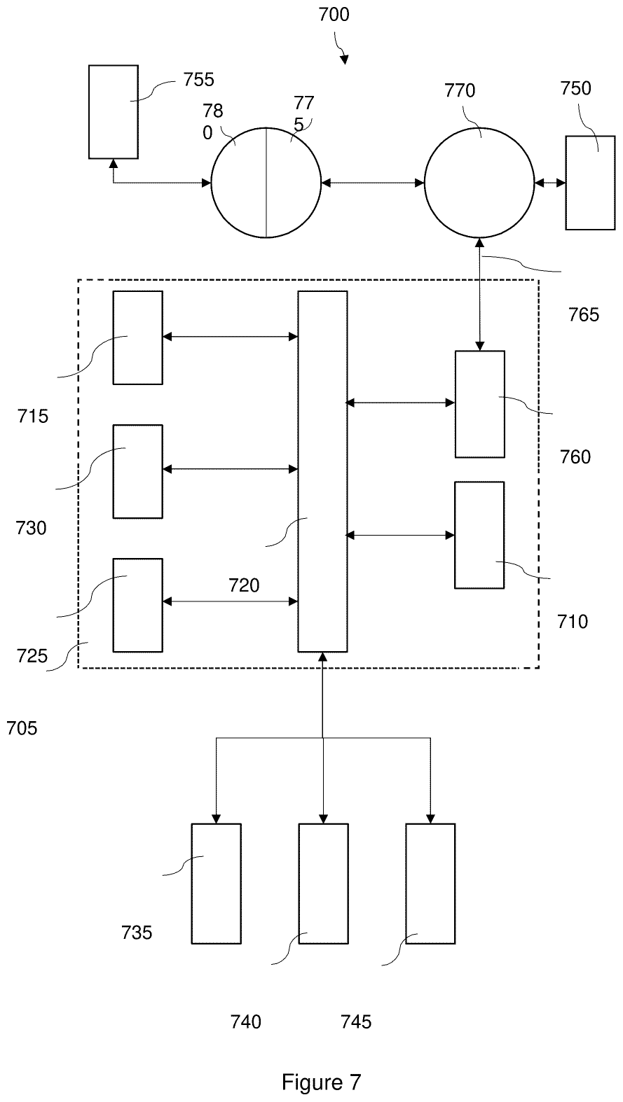

FIG. 5 shows, schematically, a software architecture 500 enabling the utilisation of the method 200 that is the subject of the present invention. This architecture 500 comprises:
at least one software template 505 defining entities 510 to be input;
at least one entity 510 input by a user;
at least one screen 515 generated by the software system 520 for generating instructions, according to at least one entity 510 input;
at least one data interface 525 generated by the software system 520 for generating instructions, according to at least one entity 510 input;
at least one process 530 generated by the software system 520 for generating instructions according to at least one entity 510 input and at least one calculation rule 535 input; and
at least one input calculation rule 535, such a calculation rule corresponding to a software processing operation.

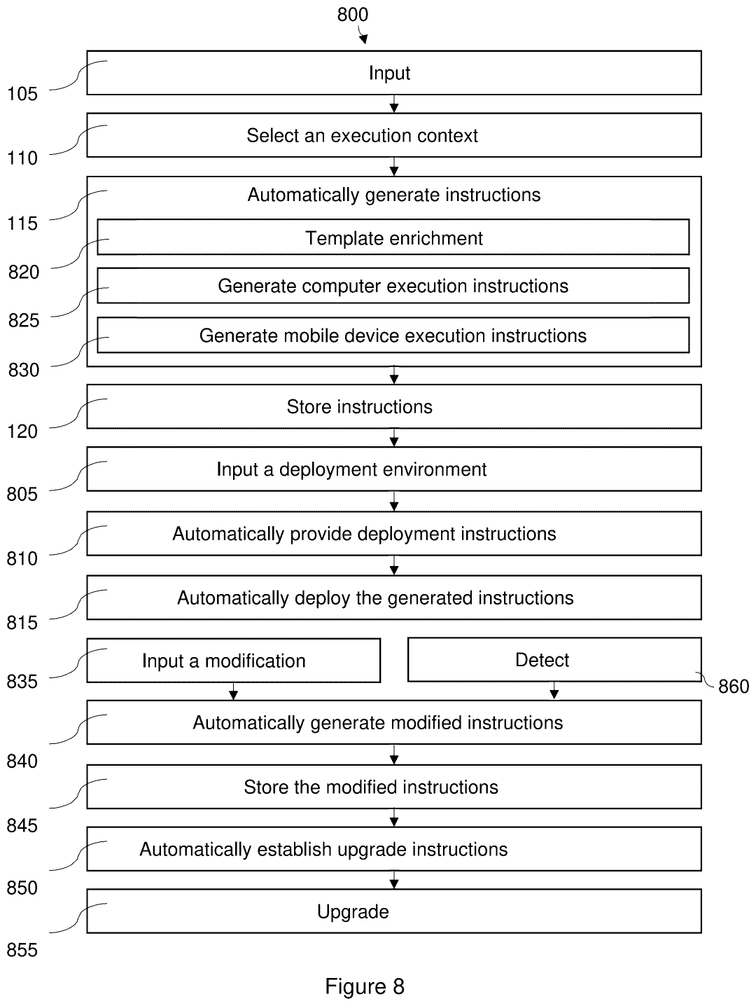

FIG. 6 shows a particular series of steps of the method 600 that is the subject of the present invention. This computer-implemented method 600 for automatically generating an application environment comprising at least two software systems, each software system being formed of instructions configured to be stored in a computer-readable storage medium and to be executed by at least one computer processor, which method comprises:
a step 105 of inputting, on a computer interface, at least:
a common definition of a computer entity,
a common structure of data associated with the computer entities, and
a common software processing operation of at least one computer entity;
a step 110 of selecting, on a computer interface, at least two different execution contexts for the instructions;
a step 115 of automatically generating, using a computing device, for at least two said software systems, instructions depending on the result of the input step and at least two selected execution contexts; which comprises, for each said software system, a step 605 of filtering the entities input depending on the selected execution context associated with the software; and
a step 120 of storing, using a computing device, for each software system, the instructions generated.

The term “application environment” refers to a body of software systems cooperating to produce a set of technical effects. Such an application environment is, for example, formed of a warehouse management software system and an online sales software system. The cooperative nature of these software systems and their close interrelationship result in a need to exchange common definitions of data between software systems. Thus the input step 105 allows a user to define entities, data structures and software processing operations, a portion of which can be shared between different sets of instructions corresponding to different software systems.

The method 600 comprises, for example, a generation step 115 for each software system to be generated. Each generation step 115 can utilise different technologies, and therefore have, for the same software processing operation, very different instructions corresponding to the technology used.

At least one generation step 115 comprises a step 605 of filtering entities. This filter step 605 is performed, for example, by utilising software executed by a computing device. During this filter step 605, only the entities utilised in a software processing operation associated to the instructions to be generated, are selected. This makes it possible to reduce the consumption of resources during the generation, deployment and execution of the instructions.

In some particular embodiments, the method 600 that is the subject of the present invention comprises:
a step 335 of modifying, on a computer interface, at least:
a common definition of a computer entity,
a common structure of data associated with the computer entities, and/or
a software processing operation of at least one computer entity; and
a step 340 of automatically generating, using a computing device, for at least two said software systems, instructions modified depending on the result of the modification step and the selected execution context; and
a step 345 of storing, using a computing device, for each software system, the instructions generated.

Therefore, as can be understood by reading the present description, the utilisation of the present invention gives the user:
the ability to describe all the functions of business software systems without writing a single line of computer code—the modelling being focused on the definition of business entities, based on which the present invention is able to automatically derive from the definition of basic behaviours of the software systems such as the screens, validation rules and data interfaces;
the ability to define standard business components making it possible to produce customised software systems very quickly while benefiting from the best practices of standard software systems; and
the ability to simulate several software systems of a different technical nature from a single template and a single software system.

1. A computer-implemented method (100, 300) for automatically generating instructions configured to be stored in a computer-readable storage medium and to be executed by at least one computer processor, comprising:
a step (105) of inputting, on a computer interface, at least:
a definition of a computer entity,
a structure of data associated with the computer entities, and
a software processing operation of at least one computer entity,
a step (110) of selecting, on a computer interface, an execution context for the instructions;
a step (115) of automatically generating, using a computing device, instructions depending on the result of the input step and the selected execution context; and
a step (120) of storing, using a computing device, the instructions generated.

2. The method (300) according to claim 1, which comprises:
a step (305) of inputting, on a computer interface, a value representative of a deployment environment for the instructions generated; and
a step (310) of automatically providing, using a computing device, deployment instructions for the instructions generated according to the value representative of a deployment environment input.

3. The method (300) according to claim 2, which comprises a step (315) of automatically deploying, using a computing device, instructions generated according to the deployment instructions supplied.

4. The method (300) according to claim 1, wherein the generation step (115) comprises a step (320) of template enrichment, using a computing device, performed depending on the result of the input step (105).

5. The method (300) according to claim 1, wherein the generation step (115) comprises:
a first step (325) of generating, using a computing device, computer execution instructions depending on the result of the input step (105) and the selected execution context; and
a second step (330) of generating, using a computing device, mobile device execution instructions depending on the result of the input step (105) and the selected execution context.

6. The method (300) according to claim 1, which comprises:
a step (335) of modifying, on a computer interface, at least:
a definition of a computer entity,
a structure of data associated with the computer entities, and/or
a software processing operation of at least one computer entity; and
a step (340) of automatically generating, using a computing device, instructions modified depending on the result of the modification step and the selected execution context; and
a step (345) of storing, using a computing device, the instructions modified.

7. The method (300) according to claim 6, which comprises a step (350) of automatically establishing, using a computing device, upgrade instructions according to the modified instructions generated.

8. The method (300) according to claim 7, which comprises a step (355) of upgrading, using a computing device, instructions deployed in a selected execution environment, according to the upgrade instructions established.

9. The method (300) according to claim 6, which comprises a step (360) of automatically detecting a version change for a library of functions utilised during a step (115) of generating instructions, the automatic generation step (340) being performed based on the change detected.

10. A computer-implemented method (600) for automatically generating an application environment comprising at least two software systems, each software system being formed of instructions configured to be stored in a computer-readable storage medium and to be executed by at least one computer processor, comprising:
a step (105) of inputting, on a computer interface, at least:
a common definition of a computer entity,
a common structure of data associated with the computer entities, and
a common software processing operation of at least one computer entity;
a step (110) of selecting, on a computer interface, at least two different execution contexts for the instructions;
a step (115) of automatically generating, using a computing device, for at least two said software systems, instructions depending on the result of the input step and at least two selected execution contexts; which comprises, for each said software system, a step (605) of filtering the entities input depending on the selected execution context associated with the software; and
a step (120) of storing, using a computing device, for each software system, the instructions generated.

11. The method (600) according to claim 10, which comprises
a step (335) of modifying, on a computer interface, at least:
a common definition of a computer entity,
a common structure of data associated with the computer entities, and
a software processing operation of at least one computer entity; and
a step (340) of automatically generating, using a computing device, for at least two said software systems, instructions modified depending on the result of the modification step and the selected execution context; and
a step (345) of storing, using a computing device, for each software system, the instructions generated.

12. A device (200) for automatically generating instructions configured to be stored in a computer-readable storage medium and to be executed by at least one computer processor, comprising:
a means (205) for inputting, on a computer interface (210), at least:
a definition of a computer entity,
a structure of data associated with the computer entities, and
a software processing operation of at least one computer entity,
a means (215) for selecting, on a computer interface, an execution context for the instructions;
a means (220) for automatically generating, using a computing device (230), instructions depending on an item of information input by the input means and the selected execution context; and
a means (225) for storing, using a computing device, the instructions generated.
